(19) United States
(12) Patent Application Publication
(10) Pub. No.: US 2024/0070156 A1
(43) Pub. Date: Feb. 29, 2024

(54) SCORE PROPAGATION ON GRAPHS WITH DIFFERENT SUBGRAPH MAPPING STRATEGIES

(71) Applicant: Oracle International Corporation, Redwood Shores, CA (US)

(72) Inventors: Kenyu Kobayashi, Lausanne (CH); Arno Schneuwly, Effretikon (CH); Renata Khasanova, Zurich (CH); Matteo Casserini, Zurich (CH); Felix Schmidt, Baden-Dattwil (CH)

(21) Appl. No.: 17/893,519

(22) Filed: Aug. 23, 2022

(51) Int. Cl. G06F 16/2457

(52) U.S. Cl. CPC G06F 16/24575

(57) ABSTRACT

Techniques for propagating scores in subgraphs are provided. In one technique, multiple path scores are stored, each path score associated with a path (or subgraph), of multiple paths, in a graph of nodes. The path scores may be generated by a machine-learned model. For each path score, a path that is associated with that path score is identified and nodes of that path are identified. For each identified node, a node score for that node is determined or computed based on the corresponding path score and the node score is stored in association with that node. Subsequently, for each node in a subset of the graph, multiple node scores that are associated with that node are identified and aggregated to generate a propagated score for that node. In a related technique, a propagated score of a node is used to compute a score for each leaf node of the node.

### TECHNICAL FIELD

The present invention relates to graph data processing and, more particularly, to different strategies for propagating scores of subgraphs to nodes within the subgraphs.

### BACKGROUND

Graphs are ubiquitous data structures applied in a vast area of science and technologies, such as Linguistics, Mathematics, Biology, Physics, Social Sciences, Electrical Engineering, and Computer Science. Graphs are capable of encoding relationships among objects in a manner that is more efficient than conventional structured datatypes, such as lists or dictionaries. For example, a graph may represent nodes in an abstract syntax tree (AST) that represents a query on a database. A machine-learned model may score different paths or subgraphs (which may overlap each other) in an AST. However, scores for paths do not reveal much information about individual nodes in those paths. What is needed is an improved way to interpret those scores.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is an example social graph that represents collaboration in a workplace environment;

FIG. 2 is a graph representation of a chemical compound;

FIG. 3 is an example abstract syntax tree (AST) for an example SQL statement;

FIG. 4 is an example graph with multiple occurrences of a particular path;

FIG. 5 is an example directed acyclic graph (DAG);

FIG. 6 is a flow diagram that depicts an example process for propagating scores from paths to individual nodes in a graph, in an embodiment;

FIG. 7 is an example of a heatmap visualization based on node scores, in an embodiment;

FIG. 8 is a flow diagram that depicts an example process for propagating path scores to individual nodes in a graph, in an embodiment;

FIG. 9 is a flow diagram that depicts an example process for propagating scores from paths to individual leaf nodes in a graph, in an embodiment;

FIG. 10 depicts a table that summarizes different propagation strategies, in an embodiment;

FIG. 11A is a block diagram that depicts an AST representation of a SQL statement;

FIG. 11B is a chart that indicates relevance scores associated with different paths in the AST;

FIGS. 12 and 12A is a block diagram that depicts a heatmap of the AST representation of the SQL statement, in an embodiment;

FIG. 13 is a chart that indicates node scores that have been assigned to leaf nodes in the AST representation using propagation techniques described herein, in an embodiment;

FIG. 14 is a block diagram that depicts a computer system upon which an embodiment of the invention may be implemented;

FIG. 15 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.
I. GENERAL OVERVIEW
II. PROBLEM DESCRIPTION
   A. GRAPHS
   B. DIRECTED ACYCLIC GRAPHS
III. GRAPH THEORY
IV. EMBODIMENTS DESCRIPTION
   A. SCORE PROPAGATION IN GRAPHS
      i. MAPPING SCORES FROM P_{F} TO P
      ii. PROPAGATING SCORES FROM P TO V
      iii. EXAMPLE PROCESS
   B. SCORE PROPAGATION IN DAGS
      i. PROPAGATING SCORES FROM V_{N} TO V_{L}
      ii. EXAMPLE PROCESS
   C. CONSERVATION PROPERTY
V. EXPERIMENT
   A. USE CASE
   B. APPLICATION
      i. PROPAGATING FROM P_{F} TO V
      ii. PROPAGATING FROM V_{N} TO V_{L}

### I. General Overview

A system and method for propagating scores on graphs with different subgraph mapping strategies are provided. In one technique, scores are propagated within arbitrary graphs. In this technique, multiple path scores are stored in data storage, each score associated with a path of multiple paths in a graph. For each path, a path score of that path is identified, multiple nodes in that path are identified, a node score is generated for each of the nodes based on the path score, and that node score is stored in association with data that identifies the corresponding node. After each path score is processed, each of multiple nodes in the graph is considered. Here, multiple node scores that have been stored in association with a particular node are identified and those node scores are aggregated to generate a propagated node score for the particular node. This aggregation may be performed for each node of multiple nodes, in the graph, that are associated with multiple node scores.

In a related technique, scores are propagated in directed acyclic graphs. Here, node scores of non-leaf nodes are propagated to leaf nodes. For a particular non-leaf node, the propagation of its node score to one or more leaf nodes of the particular non-leaf node, may be based on the number of leaf nodes of the particular non-leaf node and/or the distance of the particular non-leaf node to a leaf node.

Embodiments improve computer technology related to graph processing and score propagation in different types of graphs. In particular, the interpretability of path scores is improved by propagating path scores to individual nodes within respective paths using one or more propagating and/or aggregating strategies.

### II. Problem Description

### A. Graphs

Graphs are widely utilized within Computer Science and related fields as a popular representation of the network structure of connected data. The flow of computation, networks of communication, data organization, and source code representation are a few examples of problems that are modeled as graphs, which capture interactions (i.e., edges) between individual units (i.e., nodes). A path is a sequence of edges which joins a sequence of nodes, and is a fundamental concept used to represent relationships in graphs.

In various use-cases, insightful scores are given to paths in a graph. Embodiments improve the interpretability of such scores by propagating them to individual nodes. The “interpretability” of a thing is the capacity of that thing being understood. Scores assigned to individual nodes are more interpretable by nature, as the granularity is finer.

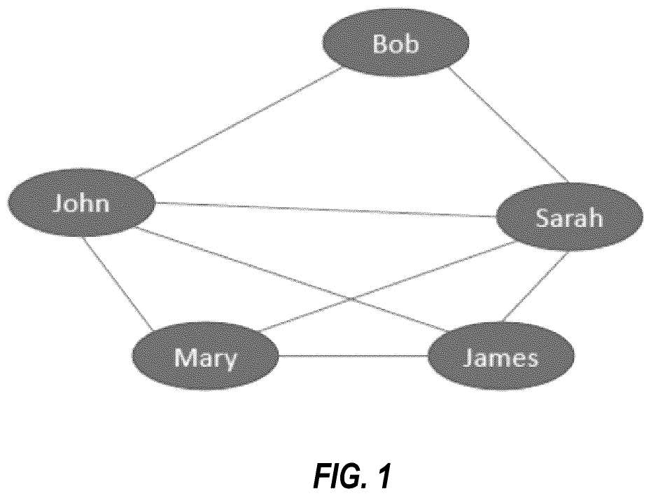

The following is an example regarding how financial profit scores are assigned to paths of a (social) graph, depicted in FIG. 1, and represents collaborations between individuals within a firm.

If two individuals have collaborated at least once on a project, then there exists an edge between the two corresponding nodes in the graph. A collaboration between individuals i₁, i₂, . . . , iₙ is represented by the path (i₁, i₂, . . . , iₙ), and is assigned a score s which is a profitability indicator of the project. Within a given timeframe, the following projects with associated profits have been carried out:
(John, Mary, Sarah, James)=8;
(John, Bob, Sarah)=2;
(Mary, Sarah)=4;
(Bob, John)=6;
   where (i₁, i₂, . . . , iₙ)=s denotes that the n individuals i₁, i₂, . . . , iₙ have collaborated on a project with profitability indicator s. Given the above, it can be determined which individual has produced the most profit for the firm. While the necessary information to answer the question is provided, deriving the correct conclusion is not a trivial matter as the collaborations vary in individuals and number of collaborators. Formally, the above question leads to assigning a score to each node in the graph, given the scores assigned to paths. For this purpose, we need a method to propagate the information contained in the path scores to individual nodes.

If two individuals have collaborated at least once on a project, then there exists an edge between the two corresponding nodes in the graph. A collaboration between individuals i₁, i₂, . . . , iₙ is represented by the path (i₁, i₂, . . . , iₙ), and is assigned a score s which is a profitability indicator of the project. Within a given timeframe, the following projects with associated profits have been carried out:

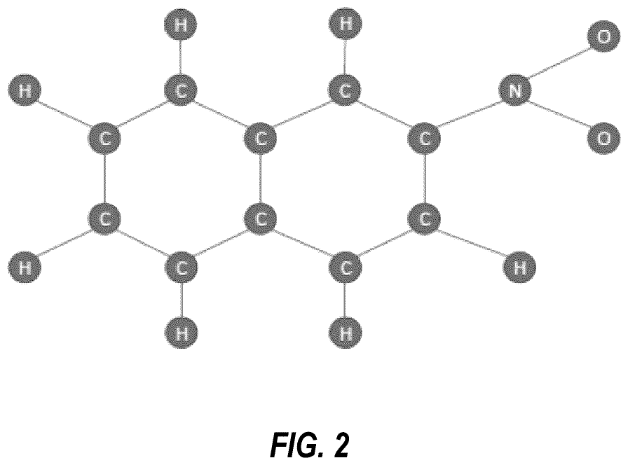

In the task of Graph Classification applied to a chemical compound dataset (e.g., the NCI dataset), each compound is represented as a graph, with atoms as nodes and bonds as edges. A chemical compound is marked positive when active against the corresponding cancer, or negative otherwise. We use the paths in the graph as features, and train a predictive model to classify the polarity of the compound. Moreover, to explain the model's output to the end-user, we apply an explainability technique. Typically, such a technique may provide an attribution-based explanation, which assigns to each input feature a relevance score reflecting the contribution to the model's decision. In this setting, we thus obtain for each input path a score underlying the importance with respect to the predicted polarity of the chemical compound. FIG. 2 illustrates an example of a chemical compound graph to be classified.

For this example, the classification is performed on four input features:
path_occ((H,C))=7;
path_occ((C,N))=1;
path_occ((C,N,O))=2;
path_occ((H,C,C))=14;
   where path_occ(p) designates the number of occurrences of the path p described by the sequence of node labels (l₁, l₂, . . . ; lₙ) in the graph.

Given that set of input features, we assume the predictive model to classify the chemical compound as positive. To understand the rationale behind the model's decision-making process, we perform an attribution-based explanation, which assigns a relevance score to each input features. This results in the following scores:
s(path_occ((H,C)))=0.3;
s(path_occ((C,N)))=0.1;
s(path_occ((C,N,O)))=0.2;
s(path_occ((H,C,C)))=0.4;
   where s(path_occ(p)) designates the score assigned to path_occ(p). Such scores assigned to paths lack interpretability for at least the following reasons.

First, scores are assigned to paths that potentially occur several times in the graph. Thus, they do not provide insights regarding the specific path occurrence that is particularly relevant for the model's decision. In the above example, the input feature path_occ((H,C,C)) receives the highest score, but the concerned path occurs 14 times in the graph. This problem is encountered when a score is assigned to a path defined as a sequence of node features instead of node IDs. More details about these two definitions of paths will be given herein.

Second, two paths, with scores s₁ and s₂ respectively, may share a common subpath. In such cases, this subpath should be considered to have a score which is a combination of s₁ and s₂. In the above example, the path (C,N) appears in two input features path_occ(C,N) and path_occ(C,N,O), and therefore may be considered to be particularly relevant to the model's decision.

As in the first example, formulating a strategy to propagate scores from paths to individual nodes in the graph would improve the interpretability of the scores. In this case, this would result in a more user-friendly explanation of the model's prediction. Notably, deriving individual node scores from the initial path scores solves the aforementioned two interpretability issues.

Thus, in an embodiment, one or more propagation strategies are implemented to improve the interpretability of scores assigned to paths in graphs. Such propagation strategies involve deriving node scores from path scores via disaggregation, as explained in more detail herein.

### B. Directed Acyclic Graphs

For the more specific case of Directed Acyclic Graphs (DAGs), a propagation strategy derives scores from paths, or non-leaf nodes, to the leaves of a DAG. A DAG is a directed graph with no directed cycles, meaning that each edge is directed from one node to another, such that following those directions never forms a closed loop. DAGs have various applications, such as the representation of source code, data processing networks, or causal structures. In such graphs, the leaves are nodes with no outgoing edges, and may represent objects of a different type than the ones represented by non-leaf nodes. “Leaf” and “leaf node” are synonymous.

For example, Abstract Syntax Trees (AST), which are DAGs used for source code representation, are composed of leaf nodes representing tokens in the source code (i.e., terminal symbols) and non-leaf nodes representing non-terminal symbols. A non-terminal symbol produces one to multiple nonterminal or terminal symbols, by following the set of syntactic rules dictated by the programming language's grammar.

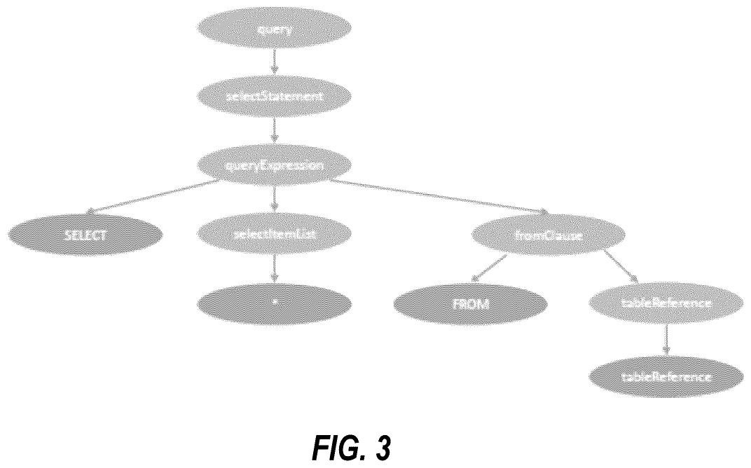

FIG. 3 illustrates an AST that represents a SQL statement. In this example, queryExpression is a non-terminal symbol producing “SELECT”, “selectItemList”, “fromClause”, among which only the former symbol is terminal. Terminal symbols are more interpretable by nature, as they represent tokens in the source code. Therefore, in an embodiment, scores assigned to non-terminal symbols (i.e., non-leaf nodes) are propagated to terminal symbols (i.e., leaf nodes). Strategies for doing so are described in more detail herein.

ASTs may be utilized to represent SQL statements to perform Anomaly Detection. To capture the semantic context and detect anomalies in SQL statements, paths of non-leaf nodes (i.e., sequence of non-terminal symbols) are extracted from the corresponding ASTs and are input to a predictive model. An attribution-based explanation applied to anomalous samples flagged by the Detection model assigns relevance scores to paths of non-leaf nodes that indicate the contribution to the anomaly. However, while scores assigned to non-terminal symbols (i.e., non-leaf nodes) may provide a first level of explanation, giving scores to terminal symbols (i.e., leaf nodes) delivers a more user-friendly interpretation to the anomaly, as this permits the highlighting of anomalous parts of SQL statements. Hence, a strategy to propagate scores from paths to leaf nodes may lead to improving the interpretability of the explanation.

### III. Graph Theory

To assist in understanding various embodiments, the following notations and theoretical background of graphs are provided.

### A. Graphs

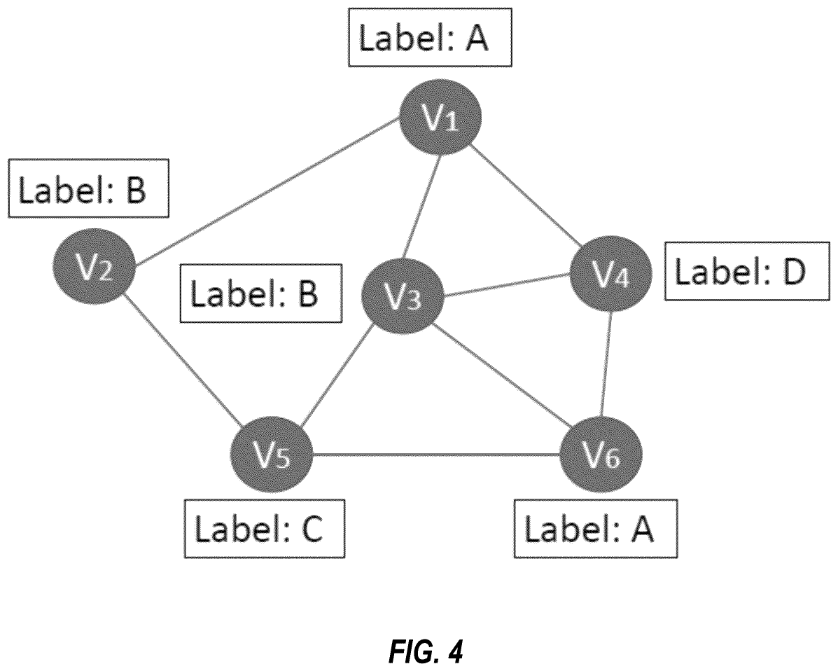

Formally, a graph G is defined as a pair G=(V, E), where V is a set of nodes, E is a set of edges (directed or undirected) between the nodes with E≤{(u, v)|u, v∈V}. A path p of length n is a sequence of edges (e₁, e₂, . . . , eₙ)=(v₁, v₂), (v₂, v₃), (vₙ, vₙ₊₁)∈Eⁿ. P is denoted as the set of all existing paths in a graph, and each path p may be referred to by the sequence of node IDs (v₁, v₂, . . . , vₙ₊₁) contained in p. For example, in FIG. 4, the path going from node 1 to node 5 through node 3 may be referred as (1, 3, 5).

Another way to describe paths is to define them as a sequence of node features. Each node v∈V in graphs may have a feature (such as label), which we refer to as v's feature, and denoted by f(v). As such, a path defined by node IDs (v₁, v₂, . . . , vₙ₊₁) can be defined by the corresponding node features (f(v₁), f(v₂), . . . f(vₙ)). P_{F} denotes the set of all existing paths described as a sequence of node features. This alternative definition of paths is useful when extracting, from a graph, contextual information related to node features (such as obtaining the number of occurrences of a given sequence of atoms, in which case the atom is the node feature; cf. FIG. 2). While a path from P occurs only once in the graph, a path from P_{F} may occur multiple times, due to the fact that two different nodes in a graph {v₁, v₂}⊆V may have the same feature f(v₁)=f(v₂). Formally, we have the definitions below.

FIG. 4 depicts a graph in which a path described by the sequence of labels (A, B, C)∈P_{F} corresponds to three different paths described by the sequence of node IDs {(v₁, v₃, v₅), (v₆; v₃; v₅); (v₁; v₂; v₅)}⊆P. In other words, map((A,B,C))={(v₁, v₃, v₅), (v₆; v₃; v₅); (v₁; v₂; v₅)}.

### B. Directed Acyclic Graphs

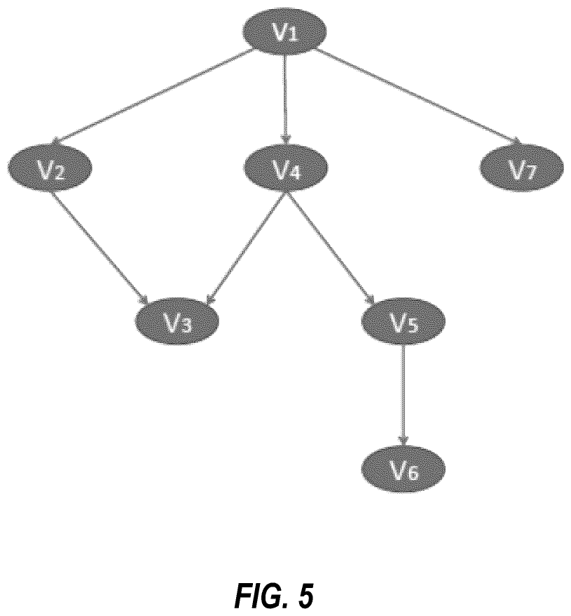

FIG. 5 illustrates an example of a DAG. An edge e∈E defined by (u, v), with u, v∈V, is directed from u to v, and is described as outgoing from u and incoming to v. A path p is a sequence of edges (e₁, e₂, . . . , eₙ)=(v₁, v₂), (v₂, v₃), . . . (vₙ, vₙ₊₁)∈Eⁿ, where an edge eᵢ is outgoing from vᵢ and incoming to vᵢ₊₁, ∀i∈{1, 2, . . . , n}. For example, in FIG. 5, (v₁; v₄; v₃) is a valid path, while (v₄; v₃; v₂) is not.

A node v₂ is a child of a node v₁ if there exists an edge outgoing from v₁ to v₂. In DAGs, there are two categories of nodes: leaf nodes and non-leaf nodes. A node that does not have any child nodes (i.e., does not have any outgoing edge) is a leaf node. Conversely, a node that has at least one child node is a non-leaf node. V_{N} denotes non-leaf nodes in a DAG and V_{L} denote leaf nodes in the DAG. In FIG. 5, V_{N}={v₁, v₂, v₄, v₅} and V_{L}={v₃, v₆, v₇}.

Furthermore, the descendant of a node vᵢ is referred to as any node vⱼ for which at least one path directed from vᵢ to vⱼ exists. The reference leaves(v) denotes the set of leaves that are descendants of a node v (also referred to as v's child leaves). For instance, leaves(4)={3, 6} in FIG. 5.

Finally, the distance between two nodes v₁, v₂∈V is referred to as the length of the shortest path between those two notes. dist(v₁, v₂) denotes the distance between v₁ and v₂. Thus, according to FIG. 5, dist(1, 6)=3.

### IV. Embodiments Description

Embodiments comprise difference strategies to improve the interpretability of path scores by propagating path scores to individual nodes in at least two main ways. First, scores are propagated from an arbitrary graph's paths (in P∪P_{F}) to nodes (in V). Second, scores are propagated from a DAG's paths (in P∪P_{F}) or non-leaf nodes (in V_{N}), to leaves (in V_{L})

For each described propagation strategy, the compatibility with the conservation property is tested, which is useful to enforce an equally distributed score propagation from a source to the destination(s).

According to the conservation property, assume that a score s(g) is propagated from a graph element (path or node) g to n other elements {g₁; g₂, . . . , gₙ} which receive {s_{g}(g₁), s_{g}(g₂), . . . , s_{g}(gₙ)} respectively. s_{g}(gᵢ) denotes the score received by gᵢ from g. The propagation of s(g) is conservative if s(g)=Σᵢ₌₁ⁿ s_{g}(gᵢ).

### A. Score Propagation in Graphs

For each described propagation strategy, the compatibility with the conservation property is tested, which is useful to enforce an equally distributed score propagation from a source to the destination(s).

For a given graph G, the existence of a set of paths with assigned scores is assumed. The paths are either from P (defined as sequences of node IDs), or from P_{F} (defined as sequences of node features).

To improve the interpretability of the path scores, a strategy is formulated to propagate the path scores from paths to individual nodes and distinguish between the two following two settings. In the first setting, when a path p_{f}∈P_{F} is assigned a score s(p_{f})∈R, propagating s(p_{f}) to nodes in the graph requires first mapping s(p_{f}) from p_{f}∈P_{F} to the corresponding set of paths map(p_{f})⊆P, using the mapping described below. This mapping leads to the second setting.

In the second setting, when a path p∈P is assigned a score s(p)∈R, s(p) is propagated to a set of nodes appearing in the path p using a strategy formulated in a section below.

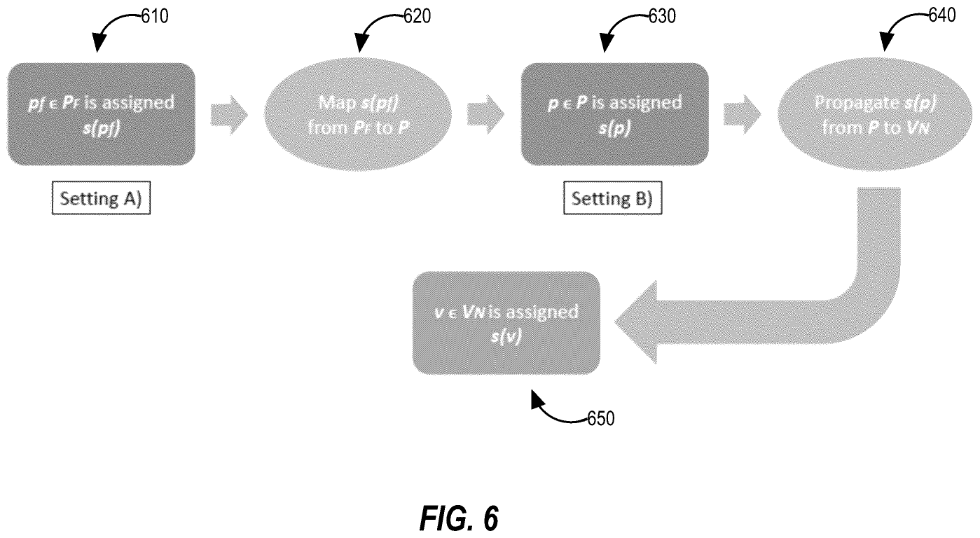

FIG. 6 is a flow diagram that depicts an example process for propagating scores from paths to nodes in a graph, in an embodiment. Block 610 corresponds to the first setting and involves assigning a score to each path that is defined by a set of one or more node features (or “node feature path”). Block 620 involves mapping the scores of such paths to a set of paths defined by node identifiers (or “node ID paths”). Block 630 corresponds to the second setting and involves assigning each path in the set of node IDS paths to a score, which is based on the score assigned in block 610. Block 640 involves propagating a path score (assigned in block 630) to individual nodes. Block 650 involves assigning each of the individual nodes a node score.

### i. Mapping Scores from P_{F} to P

The mapping of a score s(p_{f}) from a path p_{f}∈P_{F} to the corresponding set of paths map(p_{f})⊆P is achieved through the following two steps.

First, a set of paths is collected, where the set of paths are defined by map(p_{f})={p₁, p₂, . . . pₙ}⊆P. The map function is a trivial path finding algorithm. For example, given the path p_{f}=(A,B,C)∈P_{F} shown in FIG. 4, the corresponding paths are obtained: map(p_{f})={(v₁, v₃, v₅), (v₆, v₃, v₅), (v₁, v₂, v₅)}⊆P.

Second, the score s(p_{f}) is distributed equally to the corresponding set of paths. Formally, this means assigning s(p_{f})/n to each pᵢ∈map(p_{f})={p₁, p₂, . . . , pₙ}. In the example of FIG. 4, assuming that s((A, B, C))=9, this means assigning the score of 3 to each of the three corresponding paths in map((A, B, C)). This mapping follows the conservation property.

By performing these two steps over all the scored paths in P_{F}, the path scores from P_{F} are mapped to P.

### ii. Propagating Scores from P to V

Given a path p=(v₁, v₂, . . . , vₙ)∈P which is assigned a score s(p), s(p) is propagated to each vᵢ∈p as follows.

First, sₚ(vᵢ) is assigned to all nodes vᵢ∈p, where sₚ(vᵢ) is the score that is received by each vᵢ from p. Two definitions of sₚ are proposed based on a property depending on the use-case. For each definition of sₚ for score propagation, the compatibility with the conservation property is considered.

Second, one of the challenges when performing propagation is to handle the case where two scored paths p₁, p₂ share common nodes (i.e., ∃v∈V; v∈p₁\hat{ }v∈p₂). Given a node v∈V that receives two scores sₚ₁(v), sₚ₂(v) from p₁, p₂ respectively, we propose to assign s(v)=A(sₚ₁(v), sₚ₂(v)), where A is an aggregation function. In a later section, the conservation property for aggregation functions is defined, and two definitions of such functions are provided below.

A property for score propagation is that the score of a node vᵢ (i.e., sₚ(vᵢ)) depends on the number of nodes in p, which is denoted length(p). This property is referred to herein as the “length property.”

One definition for score propagation is as follows: sₚ(vᵢ)=s(p). This propagation from P to V is non-conservative and does not verify the length property.

Another definition for score propagation is as follows: sₚ(vᵢ)=s(p)/length(p). This propagation from P to V is conservative and verifies the length property.

A property for score aggregation is as follows. It is assumed that n scores are aggregated {s_{g1}(g), s_{g2}(g), . . . , s_{gn}(g)} received by a graph element g from n other elements {g₁, g₂, . . . , gₙ}, where s_{gi}(g) denotes the score received by gᵢ from g. The aggregation function A which assigns s(g)=A(s_{g1}(g), s_{g2}(g), . . . , s_{gn}(g)) is conservative if A(s_{g1}(g), s_{g2}(g), . . . , s_{gn}(g))=Σᵢ₌₁ⁿ s_{gi}(g).

One aggregation function is the sum function that assigns the sum of the node scores. Aggregating node scores with this function satisfies the conservation property: sum(s₁, s₂)=s₁+s₂.

Another aggregation function is the max function that assigns the maximum of the node scores. Aggregating node scores with this function breaks the conservation property: max(s₁, s₂)=s₁, if s₁>s₂; s₂ otherwise.

As an illustration of this propagation strategy from paths to nodes, the example graph from FIG. 4 with the following parameters are used:
The paths (v₁; v₃; v₅), (v₆; v₃; v₅) and (v₁; v₂; v₅) have scores of 3 each.
The path scores are propagated by verifying the length property.
Scores given to a same node are aggregated using the sum function.

The following node scores are obtained:

TABLE 1
Scores assigned to the nodes

| Node | Score |
|---|---|
| ν₁ | 2 |
| ν₂ | 1 |
| ν₃ | 2 |
| ν₄ | 0 |
| ν₅ | 3 |
| ν₆ | 1 |

Since the applied propagation strategy is conservative, the sum of the node scores (9) amounts to the sum of the propagated path scores (3*3=9), which in turn amounts to the initial score of the path (A,B,C).

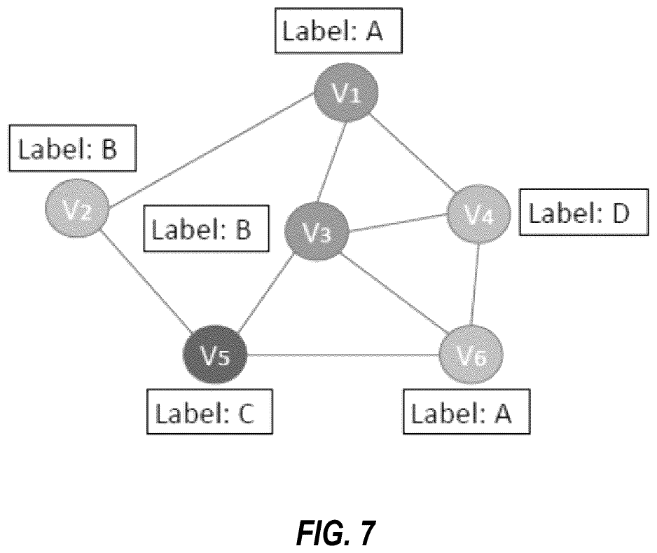

By performing the formulated propagation strategy over all the scored paths in P, scores for individual nodes in a graph are obtained, which has the potential to highlight portions of a graph with more granularity, thereby leading to improving the interpretability of a path scoring scheme. With the above score assignments, the graph depicted in FIG. 4 is visualized as a heatmap in FIG. 7.

### iii. Example Process

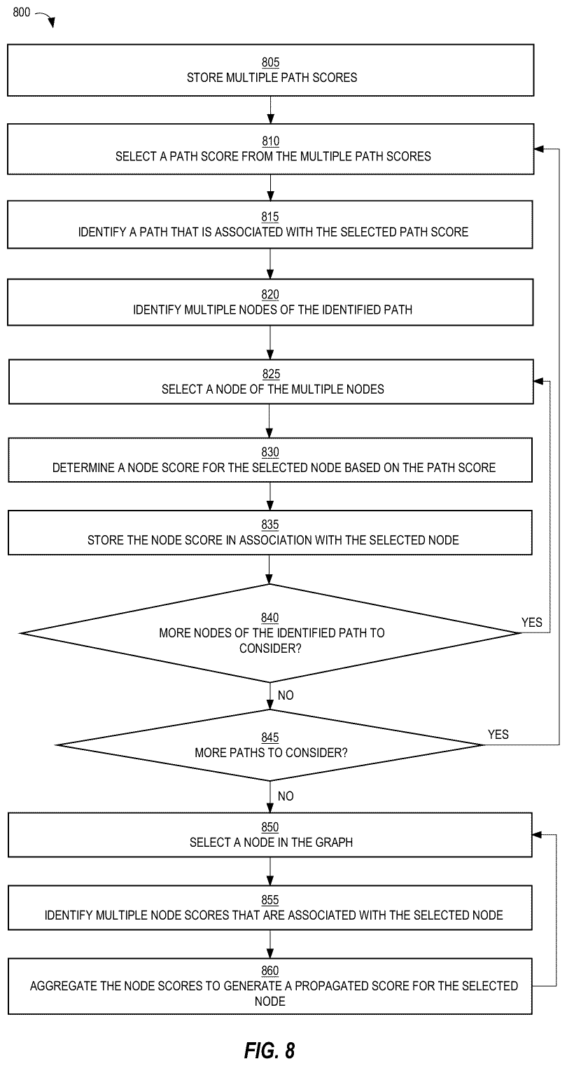

FIG. 8 is a flow diagram that depicts an example process 800 for propagating path scores to individual nodes in a graph, in an embodiment. Process 800 may be implemented by a server computer that has access to graph data (that indicates a graph) and score data that indicates multiple paths scores, each path score corresponding to a path or subgraph in the graph. Some individual paths may be associated with multiple path scores.

At block 805, multiple path scores are stored. The path scores may be stored in volatile storage media (e.g., RAM) or non-volatile storage media, such as disk storage or flash storage. Block 805 may be preceded by a path score generation process that involves a path score generator that generates path scores for paths or subgraphs in a graph. An example of a graph is a social network in a workplace, an example of a path is a set of users that comprise a team in the workplace, and an example of a path score is a number of widgets produced by that team.

At block 810, a path score of the multiple path scores is selected. Block 810 may be a random selection of a selection based on one or more selection criteria, such as selecting the score with the oldest timestamp, selecting the highest score in the set of path scores.

At block 815, a path that is associated with the selected path score is identified. Each path score may be associated with a path identifier that uniquely identifies a path within a particular graph (or within all graphs). Thus, block 815 may involve reading a path identifier in metadata that is associated with the path score. The path identifier may point to or reference a row in a database table of paths, each row providing information about a path.

At block 820, multiple nodes of the path are identified. Block 820 may involve reading a node list from a row (associated with the path identifier) in a column of a database table.

At block 825, a node of the multiple nodes is selected. Block 825 may be a random selection or based on any preexisting order of the nodes.

At block 830, a node score is determined (e.g., computed) for the selected node based on the path score. For example, the node score is made equal to the path score. As another example, the node score is the result of dividing the path score by the number of nodes in the path.

At block 835, the node score is stored in association with the selected node. For example, information about nodes in a graph are stored in a database table (or “node table”) that is separate from a database table (or “path table”) that stores information about paths in the graph. The selected node may have a node identifier that is used to identify a row in the node table. A column in the node table may be a list of node scores that have been determined or computed for the corresponding node.

At block 840, it is determined whether there are any more nodes of the selected path to consider. If so, process 800 returns to block 825. Otherwise, process 800 proceeds to block 845, where it is determined whether there are more path scores to consider. If so, then process 800 returns to block 810. Otherwise, process 800 proceeds to block 850.

At block 850, a node in the graph is selected. This may be a random selection. If this is a random selection, then block 850 may also involve determining whether the selected node is associated with multiple node scores. Alternatively, a node that is selected is one that is associated with multiple node scores. For example, a node table is scanned for rows with multiple node scores or for rows that are associated with a flag or other data that indicates that the corresponding node is associated with multiple node scores.

At block 855, multiple node scores that are associated with the selected node are identified. Block 855 may involve reading a list of node scores from a certain column in a row that corresponds to the selected node in the node table.

At block 860, the node scores are aggregated to generate a propagated score for the selected node. For example, the node scores may be summed to generate the propagated score. As another example, the highest score of the node scores is determined and assigned as the propagated score for the selected node. Block 860 may involve determining whether there are more nodes in the graph to consider. If so, then process 800 returns to block 850; otherwise, process 800 ends.

### B. Score Propagation in DAGs

For a given DAG G, the existence of a set of paths or non-leaf nodes with assigned scores is assumed. In the case of DAGs, it is assumed that these paths involve non-leaf nodes exclusively. The same notations as introduced in previous sections are used. To improve the interpretability of the scores, we formulate a strategy to propagate them to leaf nodes, and distinguish between the two following settings.

In the first setting, when a path p∈P (resp. p_{f}∈P_{F}) involving non leaf-nodes is assigned a score s(p)∈R (resp. s(p_{f})∈R), propagating s(p) (resp. s(p_{f})) to leaves in the graph requires to first propagate s(p) from p to its nodes (resp. s(p_{f}) from p_{f} to its nodes). To that end, a strategy described in previous sections regarding mapping scores from P_{F} to P and propagating scores from P to V may be followed. This propagation leads to the second setting.

In the second setting, when a non-leaf node v∈V_{N} is assigned a score s(v)∈R, s(v) is propagated to the set leaves(v)⊆V_{L} using a strategy formulated in the succeeding section.

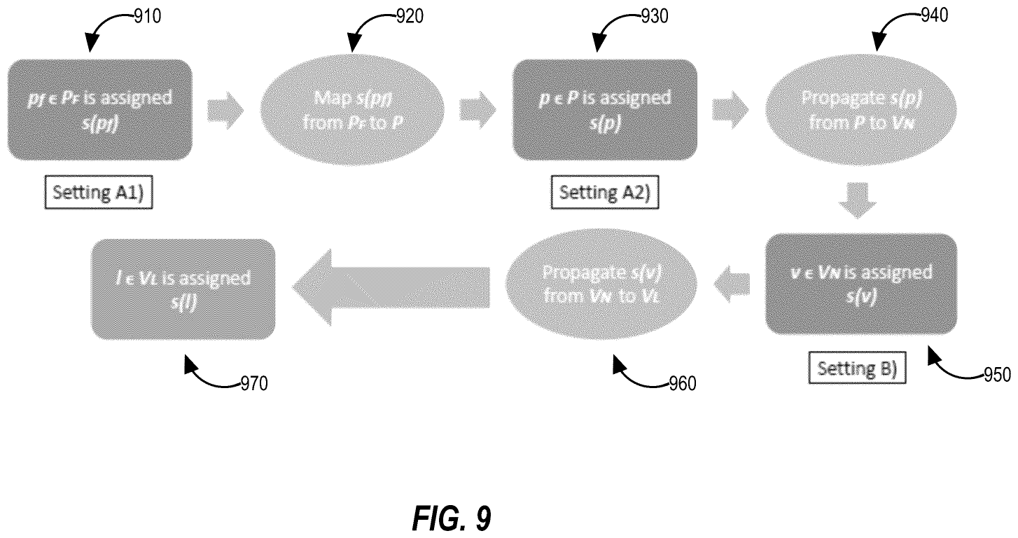

FIG. 9 is a flow diagram that depicts an example process 900 for propagating scores from paths to individual leaf nodes in a graph, in an embodiment. Blocks 910-950 are identical to blocks 610-650. Process 900 also includes block 960 that involves propagating a node score (assigned in block 940) for a non-leaf node to leaf nodes of the non-leaf node. Block 970 involves assigning the propagated score to each leaf node of the non-leaf node.

### i. Propagating Scores from V_{N} to V_{L}

The propagation of a score s(v) from a non-leaf node v∈V_{N} to leaves(v)⊆V_{L} may be performed as follows.

First, the set of v's child leaves is collected, namely leaves(v)={l₁, l₂, . . . , lₙ}⊆V_{L}.

Second, sᵥ(lᵢ) is assigned to each leaf lᵢ∈leaves(v), where sᵥ(lᵢ) is the score that is received by the leaf lᵢ∈leaves(v) from the non-leaf node v∈V_{N}. Five definitions of sᵥ are described based on two properties to be considered, depending on the use-case. For each definition of sᵥ for score propagation, compatibility with the conservation property is indicated.

Third, when multiple scores are assigned to lᵢ, those scores are aggregated using an aggregation function A. Examples of the aggregation function include sum (which satisfies the conservative property) or other non-conservative functions, such as max, min, mean, and median.

There are two main properties for score propagation from paths to leaves. One property depends on the number of child leaves (“#leaves(v)”) of a node v. The other property depends on a distance between a node v and a leaf lᵢ. This distance is referred to as dist(v, lᵢ).

The following are five example definitions for score propagation:
a. sᵥ(lᵢ)=s(v); in other words, each leaf (lᵢ) of node v is assigned the same score as the score for node v. This propagation from V_{N} to V_{L} is non-conservative and does not verify either of the two main properties for score propagation from paths or non-leaf nodes to leaves.
b.

$${s}_{v} ( {l}_{i} ) = \frac{s ( v )}{\#leaves ( v )} ;$$

in other words, each leaf (lᵢ) of node v is assigned the result of dividing the score of node v by the number of leaf nodes of node v. This propagation from V_{N} to V_{L} is conservative, verifies the first main property, but does not verify the second main property.
c.

$${s}_{v} ( {l}_{i} ) = \frac{s ( v )}{dist ( v , {l}_{i} )} ;$$

in other words, each leaf (lᵢ) of node v is assigned the result of dividing the score of node v by the distance from node v to that leaf node. This propagation from V_{N} to V_{L} is non-conservative, does not verify the first main property, but verifies the second main property.
d.

$${s}_{v} ( {l}_{i} ) = \frac{s ( v )}{\#leaves ( v ) * d i s t ( v , {l}_{i} )} ;$$

in other words, each leaf (lᵢ) of node v is assigned the result of dividing the score of node v by the product of the number of leaf nodes of node v and the distance from node v to that leaf node. This propagation from V_{N} to V_{L} is non-conservative and verifies both main properties.
e.

$${s}_{v} ( {l}_{i} ) = s ( v ) * \frac{\frac{1}{d i s t ( v , {l}_{i} )}}{{\sum }_{{l}_{j} ∈ leaves ( v )} \frac{1}{d i s t ( v , {l}_{j} )}} .$$

This propagation from V_{N} to V_{L} is conservative and verifies both main properties.

To illustrate an application of this score propagation strategy from non-leaf nodes to leaves, consider the example DAG from FIG. 5 with the following parameters:
a. The non-leaf nodes v₁, v₂, v₄, v₅ have scores of 11, 5, 3, 5, respectively;
b. The non-leaf node scores are propagated using the fifth definition above;
c. Multiple scores that are given to the same leaf node are aggregated using the sum function.

Given these paragraphs, the following scores are assigned to the following leaf nodes:

TABLE 2
Scores assigned to the leaf nodes

| Leaf Node | Score |
|---|---|
| ν₃ | 10 |
| ν₆ | 8 |
| ν₇ | 6 |

Because the employed propagation strategy is conservative, the sum of the leaf node scores (24) amounts to the sum of the propagated scores (11+5+3+5).

Finally, this approach allows for the propagation of non-leaf node scores to leaf nodes in a DAG by offering several variations depending on the definition of sᵥ. The results of the propagation approach can be visualized with a heatmap (similar to what is depicted in FIG. 7) for the leaves of a DAG. An example on a real use-case is described in more detail herein.

### C. Conservation Property

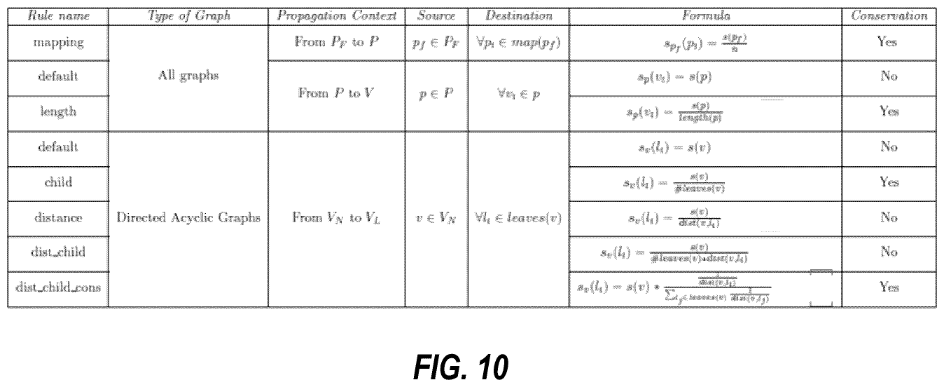

FIG. 10 depicts a table that summarizes different propagation strategies. The last five formulas in the Formula column of the table correspond to the five definitions or formulas listed in paragraph 95. Given a graph and the context of the propagation, a destination node receives a score, which is a function of the source node, given in the Propagation Rule column of the table. When a graph element receives more than one score, the scores are aggregated as described in previous sections using the sum function (conservative) and the max function (non-conservative).

### V. Experiment

### A. Use Case

In one example use case, the foregoing scoring propagation techniques are implemented in an anomaly detection system for database intrusion detection. The anomaly detection system processes database workload logs (which contain information related to the user, session, SQL statements and other attributes) to detect anomalies. The anomaly detection system may leverage Deep Neural Networks for anomaly detection. To provide insights into the decision-making process of these types of networks (which are not interpretable by their nature), embodiments add interpretability capabilities to the system. In this context, an attribution-based explanation method is implemented, referred to as Layer-wise Relevance Propagation (LRP).

Attribution-based methods indicate, for each given instance, how much each input feature in a model contributed to the prediction by assigning relevance scores. An input feature which has been assigned a relatively large score is considered to be important for the given prediction. One goal is to use an explanation framework to understand which input features have contributed most to the anomaly.

Given a datapoint (i.e., a database workload log) that is flagged as anomalous by the anomaly detection system, implementing an attribution-based explanation technique assigns relatively large relevance scores to features regarding SQL statements. In other words, the attributions explain that most anomalies originate from SQL statements. Therefore, there is great interest around the interpretation of the scores assigned to SQL statement features.

To extract features from SQL statements, the same technique as presented in section corresponding to FIG. 3 may be utilized. Paths of non-leaf nodes are extracted from the AST representing the SQL statement, along with their number of occurrences. As such, each SQL statement feature represents one sequence of non-terminal symbols (i.e., path of non-leaf nodes) in the corresponding AST representation, and the feature value is equal to the path's number of occurrences in the AST. Thus, the explanation framework assigns scores to paths in the AST that reflect their contribution to the prediction. However, for reasons elaborated upon previously, such scores lack interpretability, as they do not identify the specific part of the SQL statement or AST that is the most relevant to the decision-making process of the anomaly detector.

The following is an example SQL statement that is considered to be relevant to a prediction by an explanation framework:
SELECT * FROM user u, user login history h WHERE u.email LIKE ‘%@oracle.com’ AND u.user id=h.user id ORDER BY h.id DESC LIMIT 100

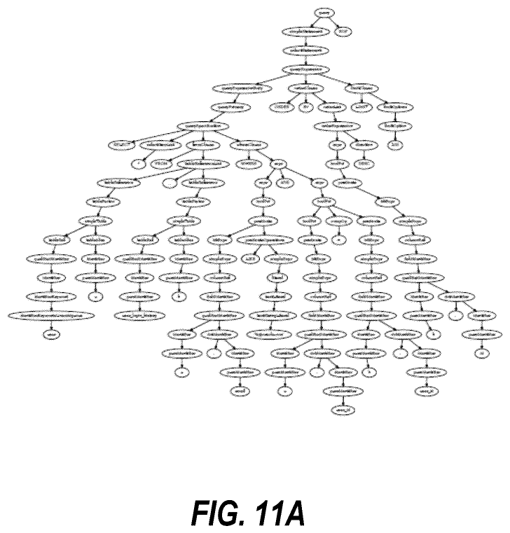

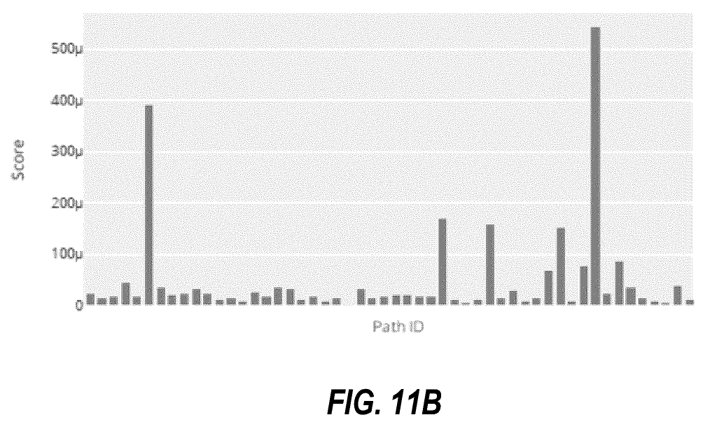

This SQL statement is flagged as anomalous because the LIKE clause is uncommon. The AST representation of this SQL statement is depicted in FIG. 11A, while FIG. 11B shows relevance scores associated with different (52) paths in the AST.

There are in total 52 scored paths {pf₁, pf₂, . . . , pf₅₂}⊆P_{F} (with P_{F} denoting the set of paths in the AST described as a sequence of non-terminal symbols, e.g., query, simpleStatement, selectStatement, etc.). Since each non-terminal symbol may appear several times in the graph, a given path p_{fi}∈P_{F} may occur multiple times, as described previously. For instance, the path (predicate, bitExpr, simpleExpr, columnRef, fieldIdentifier, qualifiedIdentifier, identifier) has four occurrences in the AST. Moreover, most of the nodes in the tree appear in more than one of the scored paths. For these reasons, it is cumbersome in practice to aggregate the information provided by each of these scores to accurately identify the part of the SQL statement (or AST) which is relevant to the explanation. The formulated propagation strategies described herein considerably improve the interpretability of the relevance scores of the respective paths.

### B. Application

To improve the interpretability of the relevance scores, multiple propagation strategies are applied as follows.

### i. Propagating from P_{F} to V

Path scores are propagated to nodes using the following propagation technique:
a. First, if the scores are assigned to {p_{f1}p_{f2}, . . . , p_{f52}}⊆P_{F}, then the scores are mapped to the following paths {map(p_{f1}), map(p_{f2}), . . . , map(p_{f52})}⊆P.
b. Second, given a path p∈P with score s(p), sₚ(vᵢ) is assigned to each node vᵢ∈p according to sₚ(vᵢ)=s(p)/length(p), which is one of the score propagation strategies described herein.
c. Third, the scores given to vᵢ may be aggregated using the sum function.

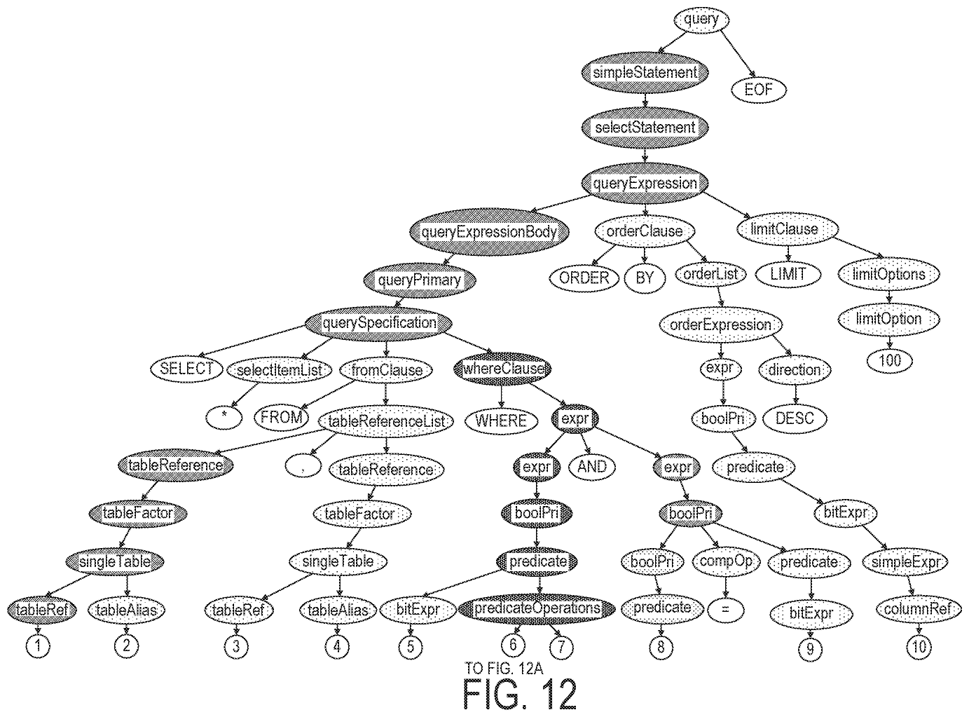

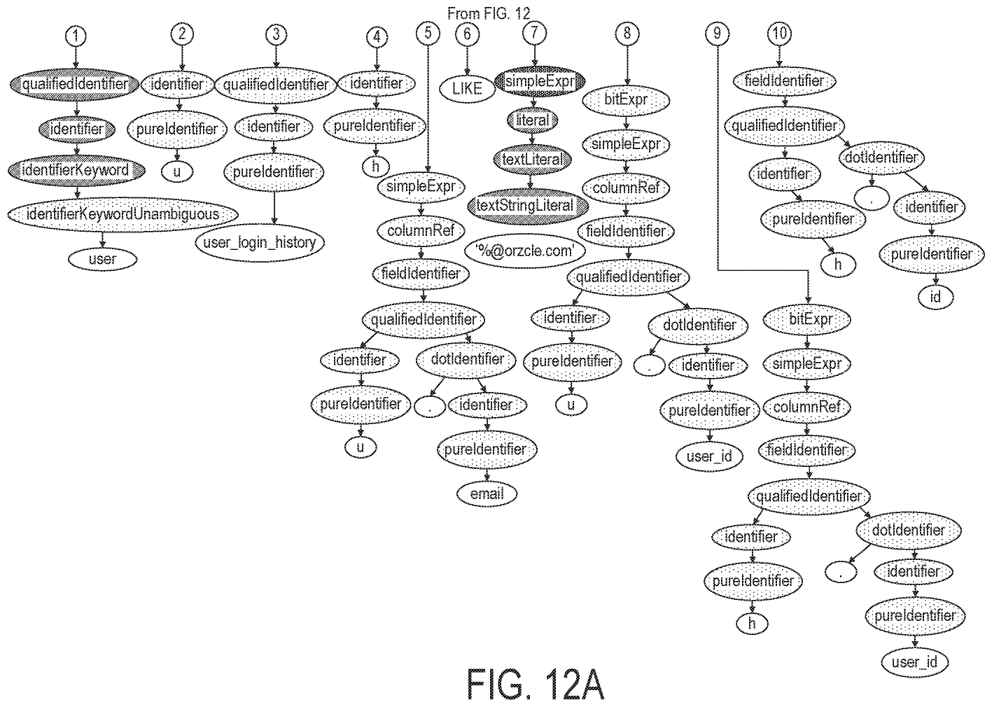

This propagation technique is conservative and assigns a score to each single non-leaf node in the AST. As such, a heatmap visualization of the AST depending on the node scores is depicted in FIGS. 12 and 12A. This heatmap represents an aggregation of the information contained in the initial scores (i.e., explanation), but is more interpretable by being visually suggestive and highlighting the most relevant nodes in the tree.

While this first result provides an explanation of the decision-process with high granularity, the interpretability is further enhanced by propagating the scores from non-leaf nodes to leaf nodes. In this case, the leaves of the ASTs correspond to tokens in the SQL statement. Therefore, propagating the scores of non-leaves to leaves provides a visualization of the explanation by highlighting the most relevant tokens in the SQL statement.

### ii. Propagating from V_{N} to V_{L}

Scores from non-leaf nodes to leaves are propagated according to the following strategy (described earlier):
a. First, a set of child leaves leaves(v)⊆V_{L} is collected for each non-leaf node v∈V_{N} with score s(v).
b. Second, sᵥ(lᵢ) is assigned to each leaf node lᵢ in leaves(v), with sᵥ defined according to the fifth propagation definition above.
c. Third, the scores given to lᵢ are aggregated using the sum function.

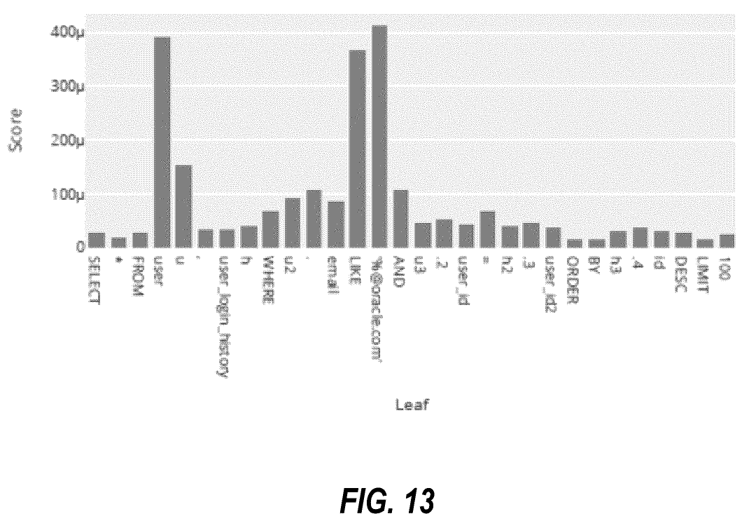

Following the above steps assigns a score to each leaf in the AST, as shown in FIG. 13.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

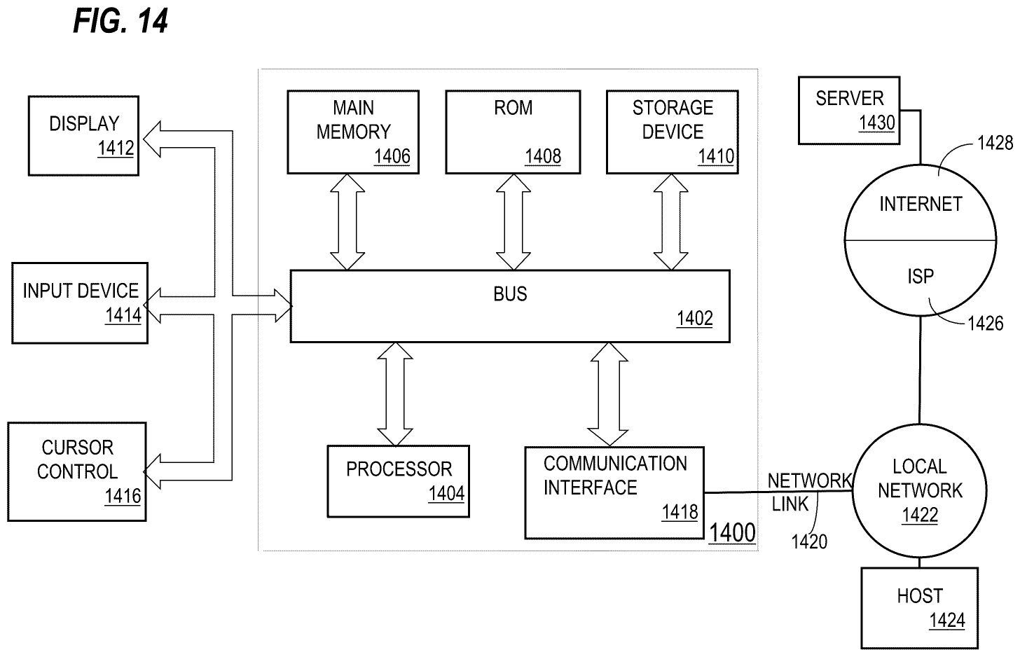

For example, FIG. 14 is a block diagram that illustrates a computer system 1400 upon which an embodiment of the invention may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk, optical disk, or solid-state drive is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1410. Volatile media includes dynamic memory, such as main memory 1406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the worldwide packet data communication network now commonly referred to as the “Internet” 1428. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### Software Overview

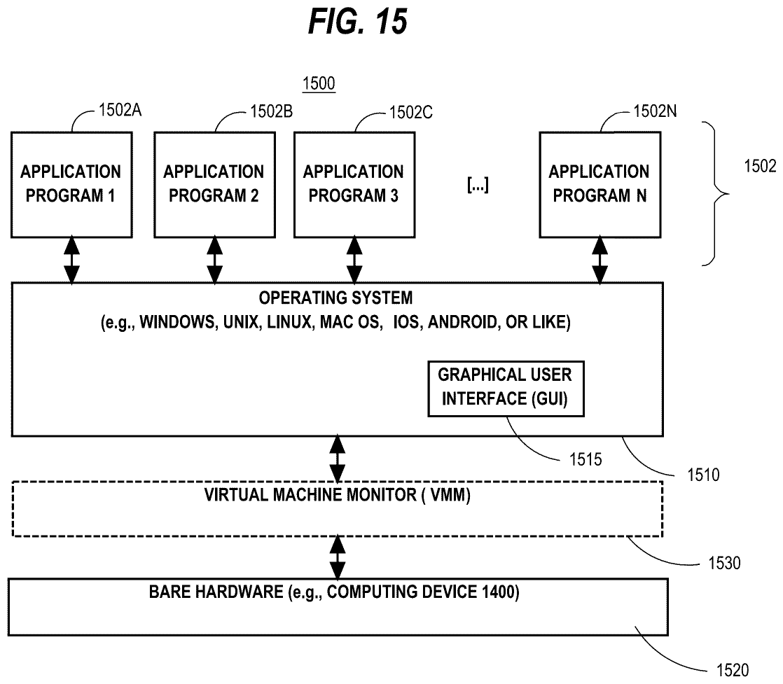

FIG. 15 is a block diagram of a basic software system 1500 that may be employed for controlling the operation of computer system 1400. Software system 1500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1500 is provided for directing the operation of computer system 1400. Software system 1500, which may be stored in system memory (RAM) 1406 and on fixed storage (e.g., hard disk or flash memory) 1410, includes a kernel or operating system (OS) 1510.

The OS 1510 manages low-level aspects of computer operation, including managing execution of processes, memory allocation, file input and output (I/O), and device I/O. One or more application programs, represented as 1502A, 1502B, 1502C . . . 1502N, may be “loaded” (e.g., transferred from fixed storage 1410 into memory 1406) for execution by the system 1500. The applications or other software intended for use on computer system 1400 may also be stored as a set of downloadable computer-executable instructions, for example, for downloading and installation from an Internet location (e.g., a Web server, an app store, or other online service).

Software system 1500 includes a graphical user interface (GUI) 1515, for receiving user commands and data in a graphical (e.g., “point-and-click” or “touch gesture”) fashion. These inputs, in turn, may be acted upon by the system 1500 in accordance with instructions from operating system 1510 and/or application(s) 1502. The GUI 1515 also serves to display the results of operation from the OS 1510 and application(s) 1502, whereupon the user may supply additional inputs or terminate the session (e.g., log off).

OS 1510 can execute directly on the bare hardware 1520 (e.g., processor(s) 1404) of computer system 1400. Alternatively, a hypervisor or virtual machine monitor (VMM) 1530 may be interposed between the bare hardware 1520 and the OS 1510. In this configuration, VMM 1530 acts as a software “cushion” or virtualization layer between the OS 1510 and the bare hardware 1520 of the computer system 1400.

VMM 1530 instantiates and runs one or more virtual machine instances (“guest machines”). Each guest machine comprises a “guest” operating system, such as OS 1510, and one or more applications, such as application(s) 1502, designed to execute on the guest operating system. The VMM 1530 presents the guest operating systems with a virtual operating platform and manages the execution of the guest operating systems.

In some instances, the VMM 1530 may allow a guest operating system to run as if it is running on the bare hardware 1520 of computer system 1400 directly. In these instances, the same version of the guest operating system configured to execute on the bare hardware 1520 directly may also execute on VMM 1530 without modification or reconfiguration. In other words, VMM 1530 may provide full hardware and CPU virtualization to a guest operating system in some instances.

In other instances, a guest operating system may be specially designed or configured to execute on VMM 1530 for efficiency. In these instances, the guest operating system is “aware” that it executes on a virtual machine monitor. In other words, VMM 1530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a plurality of path scores, wherein each path score is associated with a path, of a plurality of paths, in a graph of nodes;
for each path score of the plurality of path scores:
identifying a path, of the plurality of paths, that is associated with said each path score;
identifying a plurality of nodes in said each path;
for each node in the plurality of nodes:
based on said each path score, determining a node score for said each node;
storing the node score in association with said each node;
for each node in a subset of the graph:
identifying a plurality of node scores that are associated with said each node;
aggregating the plurality of node scores to generate a propagated score for said each node;
wherein the method is performed by one or more computing devices.

2. The method of claim 1, wherein aggregating comprises summing the plurality of node scores.

3. The method of claim 1, wherein aggregating comprises identifying the highest node score from the plurality of node scores, wherein the highest node score is the propagated score.

4. The method of claim 1, wherein determining the node score for said each node comprises:
dividing the path score by the number of nodes in said each path to generate a result; and
wherein the node score for said each node is the result.

5. The method of claim 1, wherein determining the node score for said each node comprises assigning the path score as the node score for said each node.

6. The method of claim 1, further comprising:
identifying a particular path that is defined by a set of one or more node features;
identifying a particular score for the particular path;
based on the particular path, identifying a plurality of particular paths to which the particular path maps, wherein the plurality of paths includes the plurality of particular paths;
based on the particular score, computing a score for each particular path in the plurality of particular paths.

7. The method of claim 1, wherein the graph is a directed acyclic graph, the method further comprising:
identifying a particular node that is a non-leaf node in the graph;
identifying one or more leaf nodes, of the particular node, in the graph;
identifying a particular score of the particular node;
based on the particular score, generating a leaf node score for each leaf node of the one or more leaf nodes.

8. The method of claim 7, wherein generating the leaf node score is also based on a number of leaf nodes of the one or more leaf nodes.

9. The method of claim 7, wherein generating the leaf node score of each leaf node is also based on a distance of the particular node to said each leaf node.

10. The method of claim 9, wherein the one or more leaf nodes are a plurality of leaf nodes, wherein generating the leaf node score of each leaf node is also based on a distance of the particular node to each other node, of the plurality of leaf nodes, that is different than said each leaf node.

11. The method of claim 1, wherein determining the node score satisfies a conservation property if, for each path of the plurality of paths, a sum of the plurality of node scores of nodes in said each path equal the path score of said each path.

12. One or more non-transitory storage media storing instructions which, when executed by one or more computing devices, cause:
storing a plurality of path scores, wherein each path score is associated with a path, of a plurality of paths, in a graph of nodes;
for each path score of the plurality of path scores:
identifying a path, of the plurality of paths, that is associated with said each path score;
identifying a plurality of nodes in said each path;
for each node in the plurality of nodes:
based on said each path score, determining a node score for said each node;
storing the node score in association with said each node;
for each node in a subset of the graph:
identifying a plurality of node scores that are associated with said each node;
aggregating the plurality of node scores to generate a propagated score for said each node.

13. The one or more storage media of claim 12, wherein aggregating comprises summing the plurality of node scores.

14. The one or more storage media of claim 12, wherein aggregating comprises identifying the highest node score from the plurality of node scores, wherein the highest node score is the propagated score.

15. The one or more storage media of claim 12, wherein determining the node score for said each node comprises:
dividing the path score by the number of nodes in said each path to generate a result; and
wherein the node score for said each node is the result.

16. The one or more storage media of claim 12, wherein determining the node score for said each node comprises assigning the path score as the node score for said each node.

17. The one or more storage media of claim 12, wherein the instructions, when executed by the one or more computing devices, further cause:
identifying a particular path that is defined by a set of one or more node features;
identifying a particular score for the particular path;
based on the particular path, identifying a plurality of particular paths to which the particular path maps, wherein the plurality of paths includes the plurality of particular paths;
based on the particular score, computing a score for each particular path in the plurality of particular paths.

18. The one or more storage media of claim 12, wherein the graph is a directed acyclic graph, wherein the instructions, when executed by the one or more computing devices, further cause:
identifying a particular node that is a non-leaf node in the graph;
identifying one or more leaf nodes, of the particular node, in the graph;
identifying a particular score of the particular node;
based on the particular score, generating a leaf node score for each leaf node of the one or more leaf nodes.

19. The one or more storage media of claim 18, wherein generating the leaf node score is also based on a number of leaf nodes of the one or more leaf nodes.

20. The one or more storage media of claim 18, wherein generating the leaf node score of each leaf node is also based on a distance of the particular node to said each leaf node.
